(19) United States
(12) Patent Application Publication
(10) Pub. No.: US 2004/0129927 A1
(43) Pub. Date: Jul. 8, 2004

(54) Hydraulic jack

(76) Inventor: Tae-Hong Ha, Seoul (KR)

Correspondence Address: STITES & HARBISON PLLC, 1199 NORTH FAIRFAX STREET, SUITE 900, ALEXANDRIA, VA, 22314, US

(21) Appl. No.: 10/476,253

(22) PCT Filed: May 2, 2002
(86) PCT No.: PCT/KR02/00819

(30) Foreign Application Priority Data
May 2, 2001 (KR) 2001/23822

(51) Int. Cl. B66F 3/24

(52) U.S. Cl. 254/93 R

(57) ABSTRACT

Disclosed is a jack lever, in which oil is pumped by piston(10) to move a cylinder(20) faster, vacuum being created at a lower portion of the cylinder(20) moving up, oil in an oil tank(01) being then flowed in the lower portion through an oil suction channel to make the cylinder move up faster. If the cylinder(20) moves upward to push up a work piece, load is exerted into the cylinder(20), so making the piston(10) pumping oil stronger, the oil opening a check ball(15a) mounted on a bypass channel(15) by the pumping and being supplied to the lower portion of the cylinder(20) to move the cylinder up. At this time, the cylinder(20) moves slower but increases ascending force, thus requiring small power to manipulate a jack lever (not shown) pumping the piston(10).

### TECHNICAL FIELD

The present invention relates to a hydraulic jack for lifting various work pieces such as a vehicle.

### BACKGROUND ART

Generally, a jack is convenient to carry owing to its small volume and frequently used to lift a vehicle body itself for changing a tire or repairing the vehicle. A lifter is used to lift rather bigger work piece such as from a compact car till 8-ton dump, so having large volume and heavy weight not to be carried. The lifter is usually used in a maintenance station.

Such a conventional hydraulic jack or lifter has an advantage of easily safely lifting a large object with a relative lower force. The conventional hydraulic jack or lifter needs to pump oil by reciprocate a jack lever or handle like levering in order to lift a work piece to a desired height. In other words, there is an inconvenience to manipulate the handle repeatedly till contacting to a bottom of the vehicle body.

The conventional hydraulic jack or lifter is also unhandy since it requires so much strength to manipulate the lever due to load of a lifted object. If the jack or lifter is moved utmost, the jack does not move upward and the jack lever is also not manipulated any more. In addition, excessive load or hydraulic pressure inside the jack or lifter may cause breakage of a sealing such as O-ring or gasket, so leakage of the oil.

### DISCLOSURE OF INVENTION

The present invention is designed to solve such problems of the prior art, and an object of the invention is to provide a hydraulic jack, which moves upward rapidly until a jack or lifter contacts with a bottom of a work piece, but strengthens lifting force rather than speed after the jack or lifter contacts the bottom.

Another object of the present invention is to provide a hydraulic jack, in which the output of a jack is improved as well as less power is needed to manipulate a jack lever.

Still another object of the present invention is to provide an improved jack, which eliminates excessive pressure caused by excessive load, or when a load of an object is too big for the jack to lift, by automatically discharging oil to an oil tank, thus protects the jack and prevents immoderate lifting and thus possibility of accident in advance.

Further object of the present invention is to provide a hydraulic jack having improved output so as to be employed in a broad range from small work pieces to large objects, and a lifter using the hydraulic jack.

The present invention therefore provides the following technical solutions: (i) moving rapid till reaching a bottom of a work piece; (ii) stably lifting the work piece at a low speed when reaching the bottom of the work piece and substantially lifting up the work piece; (iii) capable of manipulating a jack lever of heavy load with a small power; (iv) strengthening output of the jack; and (v) protecting the jack by sending hydraulic pressure back to an oil tank in case of excessive load and preventing possibility of accident in advance by designing the jack not to compulsorily lift an object with load exceeding the jack capacity.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a sectional view exemplarily showing a preferred embodiment of the present invention;

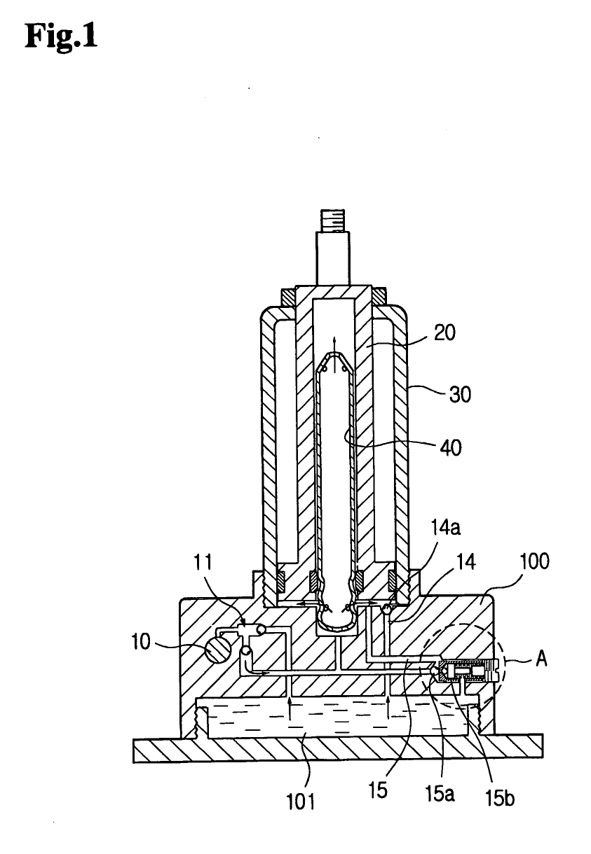

FIG. 2 is a sectional view, similar to FIG. 1, showing an operational state of a hydraulic jack;

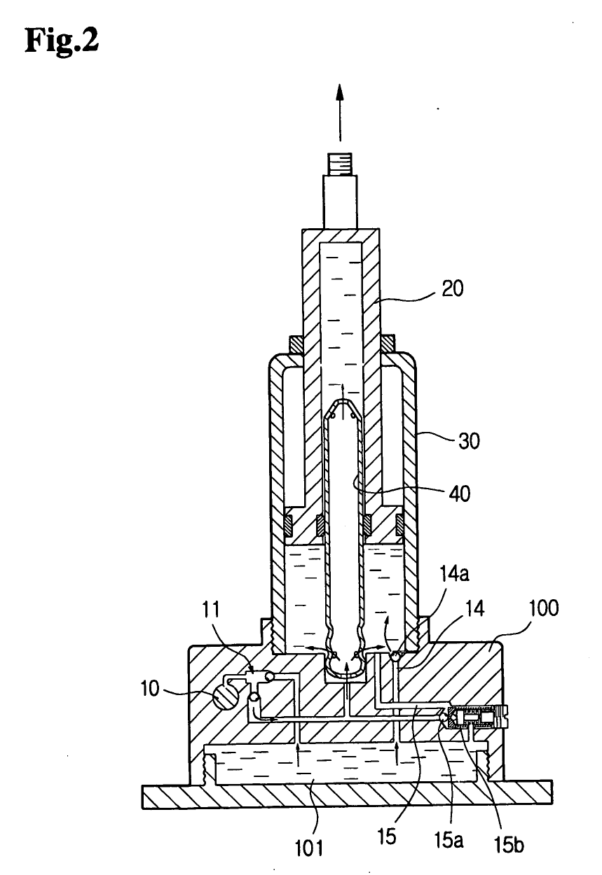

FIG. 3 is a horizontal sectional view showing essential parts of FIG. 1;

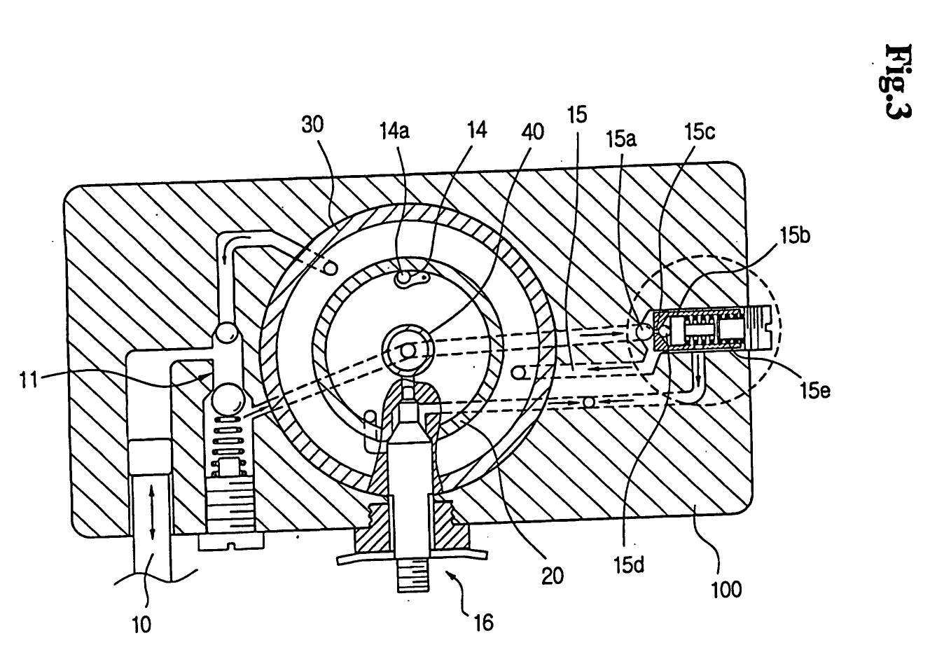

FIGS. 4a and 4b are enlarged sectional views showing A portion of FIG. 3, in which FIG. 4a shows a retreat state of a check ball by hydraulic pressure, while FIG. 4b shows a retreat state of a pilot;

FIG. 5 is an exploded perspective view showing a jack according to a modified embodiment of the present invention;

FIG. 6 is a vertical sectional view showing essential parts of FIG. 5;

FIG. 7 is a sectional view, similar to FIG. 6, showing operation of a cylinder;

FIG. 8 is a horizontal sectional view showing essential parts of a hydraulic jack shown in FIG. 5;

FIGS. 9a and 9b are enlarged views of B portion of FIG. 6;

FIG. 10 is a perspective view showing an example of lifter employing the hydraulic jack according to the present invention; and

FIG. 11 is an exploded view of the lifter shown in FIG. 10.

### BEST MODES FOR CARRYING OUT THE INVENTION

Hereinafter, preferred embodiments of the present invention will be described in detail with reference to the accompanying drawings.

A hydraulic jack of the present invention includes a piston 10 having an oil tank 101 and a first check valve 11 combined to a jack lever for pumping oil in the oil tank 101 so that pumped oil does not return to the oil tank 101; an outer barrel 30 for supporting a cylinder 20 to be vertically movable, the outer barrel 30 being sealed by a sealing member having an injection tube 40 to supply into the cylinder 20 the oil pumped by the piston 10; an oil suction channel 14 having a check ball 14a, which is communicated with the oil tank 101 when the cylinder 20 moves upward by hydraulic pressure of the oil injected through the first check valve 11 so that the oil is directly flowed in a lower portion of the cylinder 20, thus supplying oil to the cylinder 20 in addition to the pumped oil so as to make the cylinder 20 move faster; a bypass channel 15 for flowing the hydraulic pressure into the lower portion of the cylinder 20 when a predetermined load of a work piece is exerted to a free end of the cylinder 20 to make the check ball 15a open so that the cylinder 20 moves slower; and a manifold housing 100 having an openable hydraulic pressure eliminating valve 16 communicated with inside of the cylinder 20 and the injection tube 40 or the lower portion of the cylinder 20 for eliminating the hydraulic pressure by discharging the hydraulic pressure to the oil tank 101.

The hydraulic jack of the present invention may make the cylinder 20 move upward rapidly by means of flowing oil in the cylinder 20 as well as the lower portion of the cylinder 20, in other words by pumping oil by the piston 10 into the cylinder 20 as well as sucking the oil in the oil tank 101 through the oil suction channel 14 into the lower portion of the cylinder 20 using vacuum pressure instantaneously generated when the cylinder 20 moves up.

And, if the cylinder 20 moves up to push the work piece upward, the piston 20 should be more strengthened since a load is exerted into the cylinder 20. Thus, the oil opens the check ball 15a mounted on the bypass channel 15 by using the pumping pressure so that the oil makes a detour toward the lower portion of the cylinder 20, thus moves the cylinder upward.

At this time, the cylinder 20 gets having stronger force upward in spite of lower speed. In addition, a jack lever (not shown) pumping the piston 10 can be manipulated with relatively less power.

Though there is needed a relatively greater pumping pressure to move the cylinder upward when a very big load is exerted inside the cylinder, the hydraulic jack of the present invention as described above solves the problem that the jack lever is difficult to manipulate (reciprocation of the piston). In addition, to solve a problem that, if the piston 10 is operated when the cylinder 20 is sufficiently moved upward to the top, a sealing member prepared between the cylinder 20 and the injection tube 40 can be broken down due to the pumping pressure, the hydraulic jack of the present invention may an automatic hydraulic pressure save means.

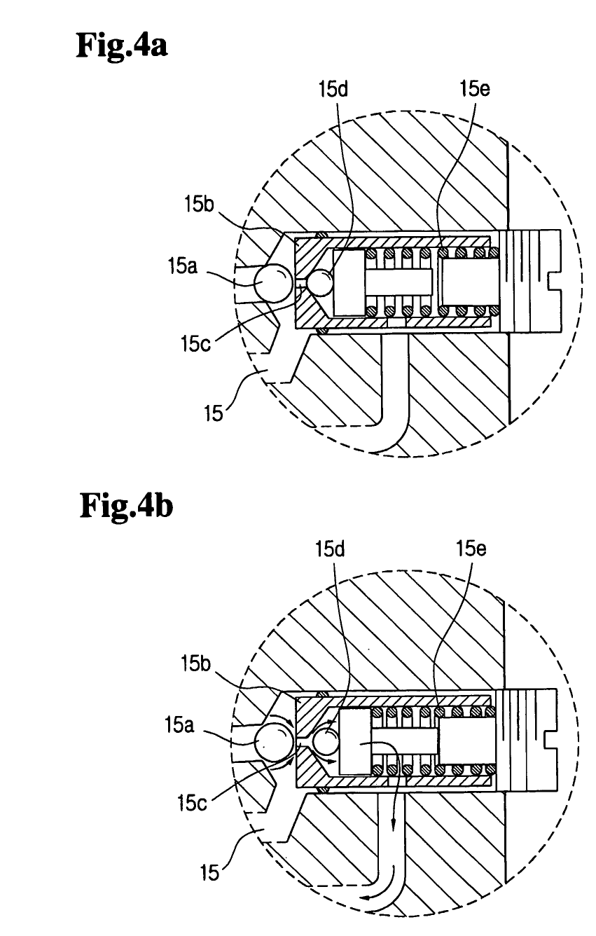

As an example of the automatic hydraulic pressure save means, as shown in FIG. 4b, there is formed a through hole 15c communicated with inside thereof at an end of a pilot 15b pressing a rear of the check ball 15a mounted on the channel 15, and another check ball 15d is installed in the through hole 15c so as to block the through hole 15c by elasticity of a spring 15e. When the check ball 15d moves back, the oil flowed in the through hole 15c can be moved into the oil tank 101.

The save means is operated as follows. If the cylinder 20 pushes up the work piece to exert excessive load over predetermined pressure, the oil pumped by pressure over the load retreats the pilot 15b, which is elastically pushing the check ball 15a of the bypass channel 15. Thus, the oil detours to the lower portion of the cylinder so that the cylinder 20 moves upward slowly. Then, if the load increases more or the cylinder is moved to the top, not capable of ascending, the end of the pilot 15b moves back by the pumped oil pressure. At this time, the check ball 15a and the pilot 15b get spaced apart so that the through hole 15c becomes exposed.

Thus, while the check ball 15d retreats with overcoming elasticity of the spring 15e by the oil flowed in the through hole 15c of the pilot 15b, the oil gets induced in the through hole 15c. At this time, while the oil, induced in the through hole 15b when the pilot 15b is communicated with the oil tank 101 by retreat of the pilot 15b, returns into the oil tank 101, the excessive hydraulic pressure exerted in the jack is automatically eliminated.

The spring 15e is retracted when the load exerted to the cylinder 20 is at least more than the elasticity of the spring 15e. For example, in case of a hydraulic jack for a compact vehicle, the spring 15e is retracted when the exerted load is over about 1.5 kg.

If the hydraulic jack experiences more than about 1.5 kg of load for example, the oil returns to the oil tank 101 so that the cylinder 20 moves downward with the oil therein being eliminated. The capacity of the jack is increased or decreased when the elasticity of the spring 15e is increased or decreased.

Thus, the hydraulic jack can be protected against the exerted load exceeding the capacity of the hydraulic jack, and falling accident caused by overwork lifting can be prevented in advance.

As described above, it would be understood that the capacity of the hydraulic jack of the present invention can be set in broad range by setting elasticity of the springs as desired.

As another embodiment, the hydraulic jack of the present invention can be modified so that the cylinder 20 has at least two stages, which can be piled each other.

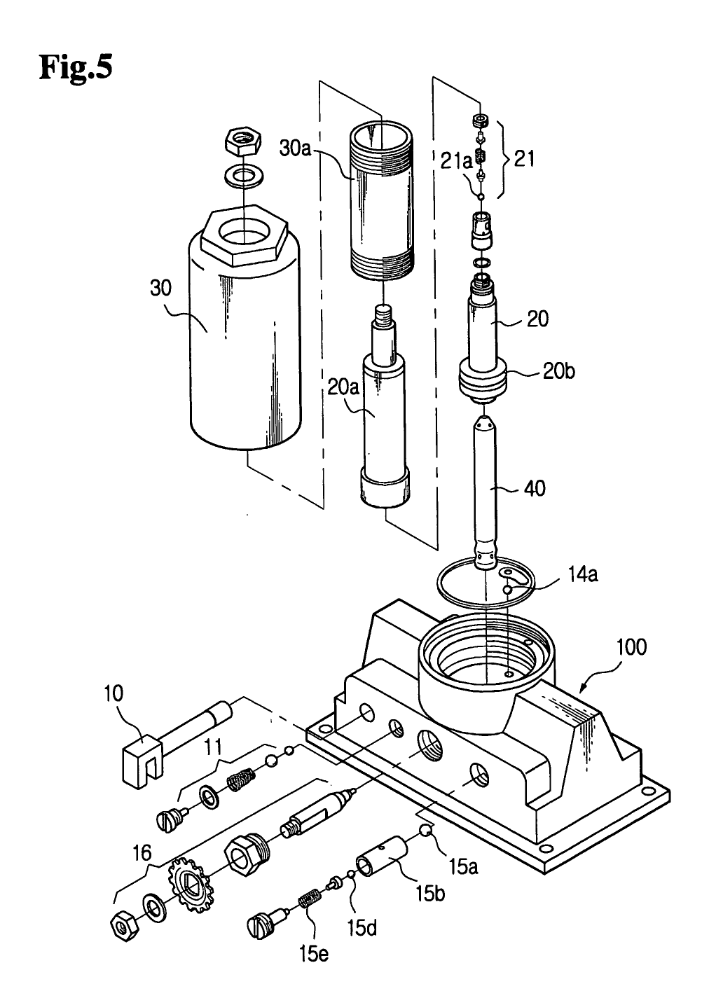

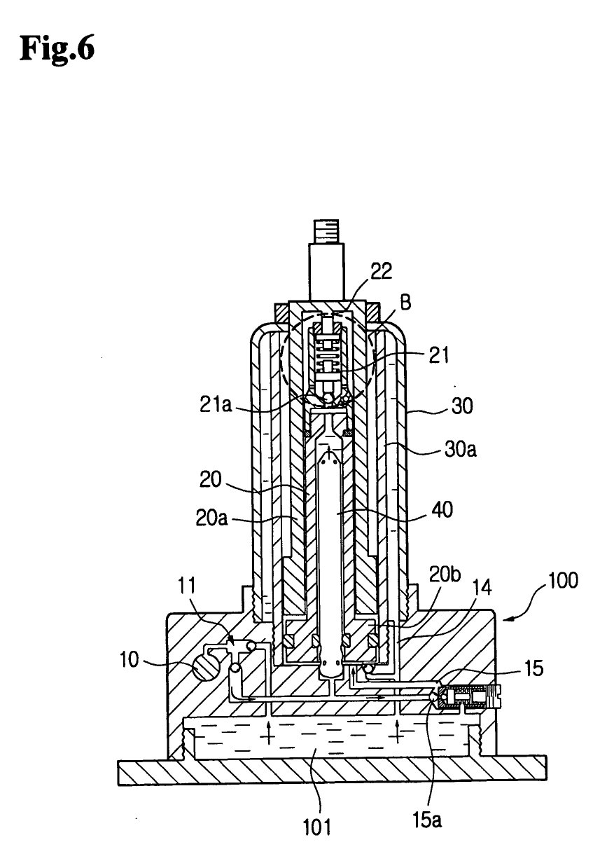

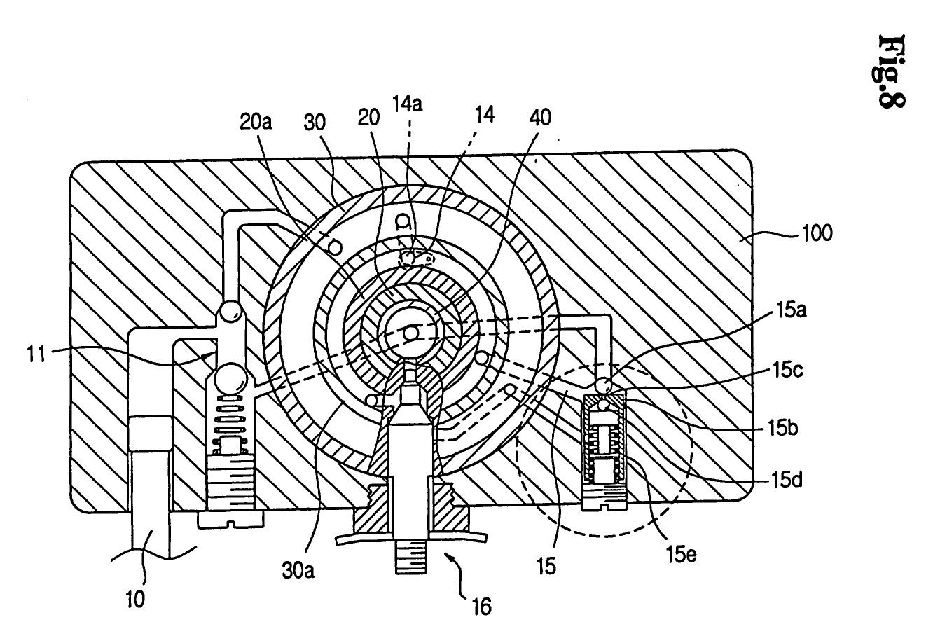

In this modified embodiment, as shown in FIGS. 5 to 9, the cylinder 20 is divided to have additional outer cylinder 20a, which is slidably combined to the inner cylinder 20. At this time, a flange 20b is formed at a lower end of the inner cylinder 20 to push the outer cylinder 20a upward. And, there may be prepared a check valve assembly 21 between the inner cylinder 20 and the outer cylinder 20a. The reference numeral 21c denotes a fine channel used for eliminating oil in the outer cylinder 20a, and has an one-directional check valve. Reference numeral 30a denotes an inner wall partitioned to configure the oil tank 101 in the outer barrel. This oil tank is communicated with the oil tank disposed below.

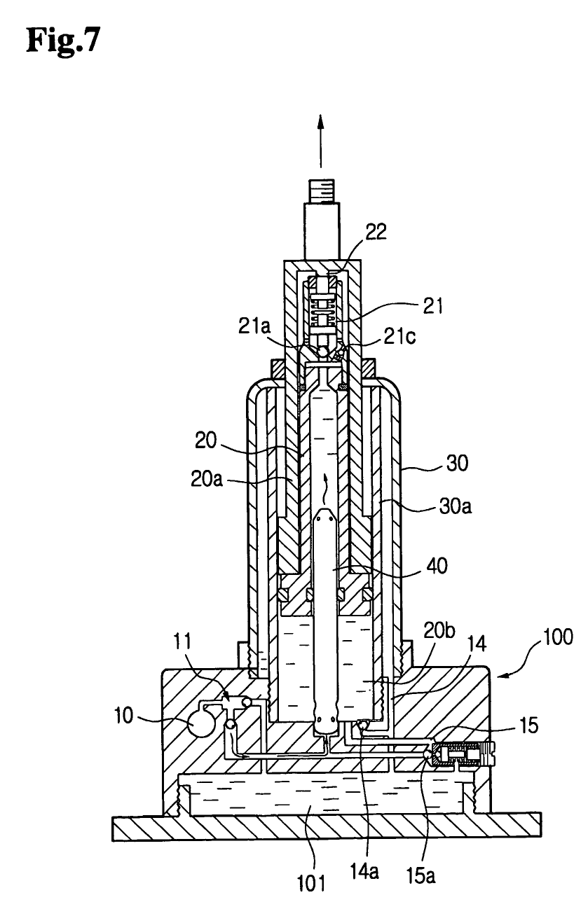

In this modification, the inner cylinder 20 initially moves up when the pumped oil is flowed in the inner cylinder 20, as shown in FIG. 7, and then the flange 20b pushes up the outer cylinder 20a. As the outer cylinder 20a moves upward, an end of the outer cylinder 20a contacts with the work piece. Thus, the load of the work piece is exerted on the outer cylinder 20a to pump oil stronger. Then, the check ball 21a retreats by the pumping pressure so that fluid can be flowed in the channel 21b, so moving the outer cylinder 20a upward. Since the outer cylinder 20a has an inner volume less than that of the inner cylinder 20, the outer cylinder 20a moves faster for same pumping.

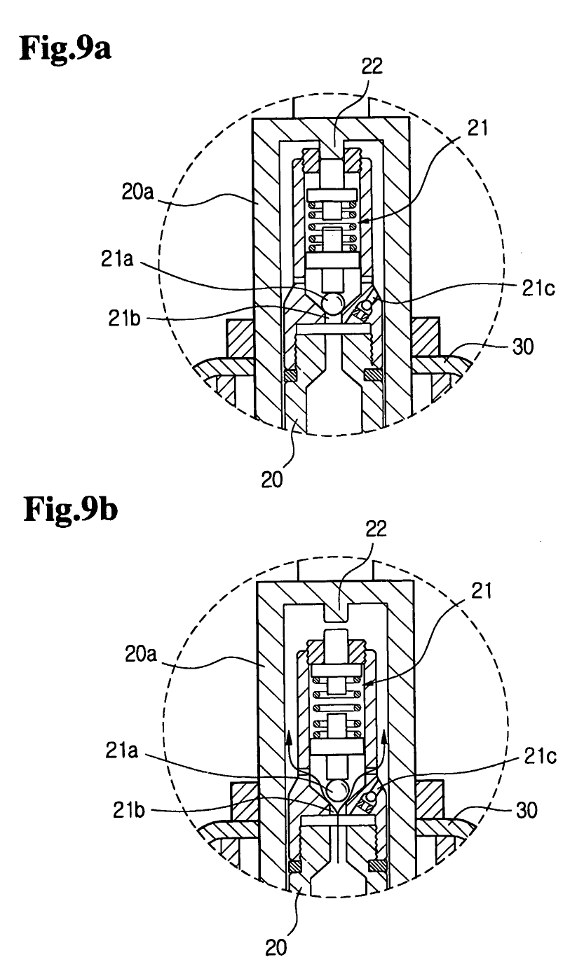

In addition, the valve assembly has a protrusion 22 formed at an inner side of the outer cylinder 20a to press a rear of the check valve 21 when the outer cylinder 20a moves down, as shown in FIGS. 9a and 9b. Thus, the inner cylinder 20 initially moves up firstly, and when a predetermined load is exerted to the cylinder, the outer cylinder 20a is moved up with the check ball 21a being open, by which the cylinder can move up with relatively smaller power. Thus, since the hydraulic jack can rapidly move up to the bottom of the work piece, there is no need to manipulate the jack lever.

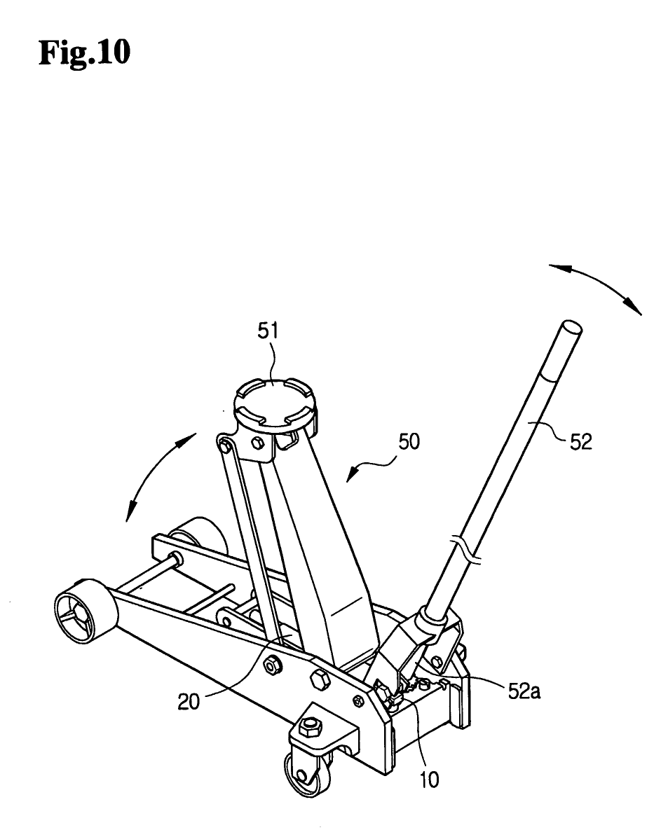

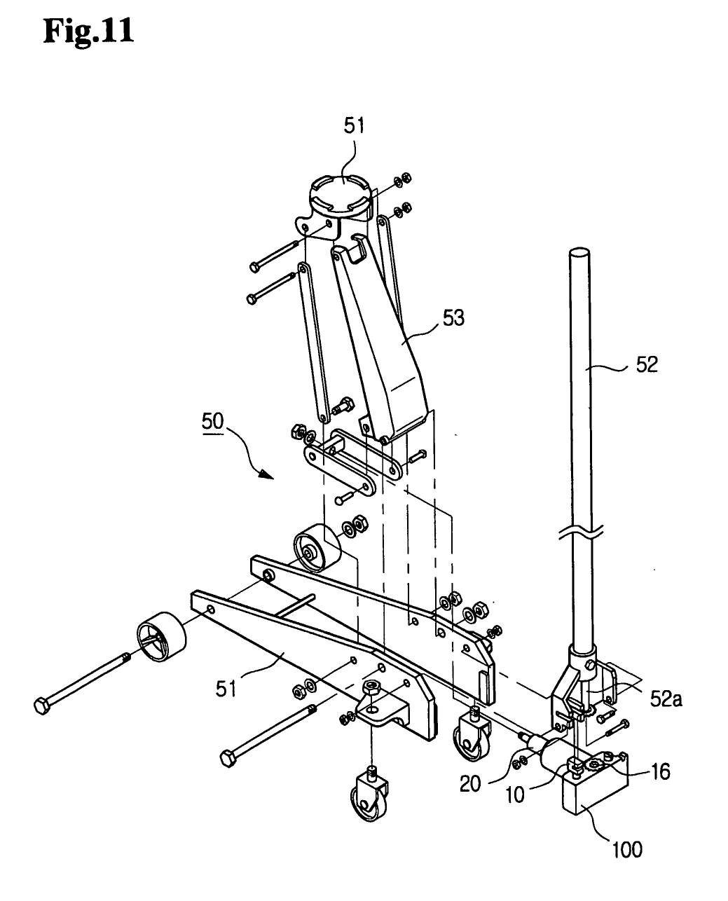

FIGS. 10 and 11 are a perspective view and an exploded perspective view showing an example that the hydraulic jack of the present invention is adopted to a lifter, respectively. Referring to FIGS. 10 and 11, a free end of the cylinder 20 is pivotably combined to an arm 53, which is also pivoted. Thus, the arm rotates on a pivot axis depending on length of the cylinder 20 so as to adjust height of a ram 51. Therefore, owing to power caused by the ascent of ram 51, the work piece can be lifted.

At this time, the piston 10 is linked to the arm 53 so as to be work together when manipulating the handle 52 up or down. Also, the piston 10 can be manipulated by rotating a pressure eliminating shaft 52a extended into the handle 52 for connection to a pressure eliminating valve 16.

As described above, the hydraulic jack of the present invention can be applied to various fields such as a lifting device when connecting jacks for bridge upper plate to supports of buildings or tower crane, in addition to the lifting device using length of the hydraulic length.

By using the present invention, work efficiency and convenience can be obtained since light and heavy objects can be used at the same time. Additionally, in case of using the device such as a lifter to which the hydraulic jack of the present invention is applied, a worker may make the cylinder move faster to lift a light object, which makes the work convenient and rapid. Moreover, because the oil pressure is adjustable depending on load and position of the work piece on the cylinder, the work can be more stable.

What is claimed is:

1. A hydraulic jack comprising:
a piston (10) having an oil tank (101) and a first check valve (11) combined to a jack lever for pumping oil in the oil tank (101) so that pumped oil does not return to the oil tank (101);
an outer barrel (30) for supporting a cylinder (20) to be vertically movable, the outer barrel (30) being sealed by a sealing member having an injection tube (40) to supply into the cylinder (20) the oil pumped by the piston (10);
an oil suction channel (14) having a check ball (14a), which is communicated with the oil tank (101) when the cylinder (20) moves upward by hydraulic pressure of the oil injected through the first check valve (11) so that the oil is directly flowed in a lower portion of the cylinder (20), thus supplying oil to the cylinder (20) in addition to the pumped oil so as to make the cylinder (20) move faster;
a bypass channel (15) for flowing the hydraulic pressure into the lower portion of the cylinder (20) when a predetermined load of a work piece is exerted to a free end of the cylinder (20) to make the check ball (15a) open so that the cylinder (20) moves slower; and
a manifold housing (100) having an openable hydraulic pressure eliminating valve (16) communicated with inside of the cylinder (20) and the injection tube(40) or the lower portion of the cylinder (20) for eliminating the hydraulic pressure by discharging the hydraulic pressure to the oil tank (101).

2. A hydraulic jack according to claim 1, further comprising an automatic hydraulic pressure save means for automatically sending the oil back to the oil tank (101) when an excessive load is exerted in the manifold housing (100).

3. A hydraulic jack according to claim 2,
wherein the automatic hydraulic pressure save means has a through hole (15c) communicated with inside thereof at an end of a pilot (15b) pressing a rear of the check ball (15a) mounted on the channel (15), and another check ball (15d) in the through hole (15c) so as to block the through hole (15c) by elasticity of a spring, the oil flowed in the through hole (15c) being movable into the oil tank (101) when the check ball (15d) moves back.

4. A hydraulic jack according to claim 1,
wherein the cylinder (20) has multiple stages piled each other in which a flange (20b) is formed at a lower end of the inner cylinder (20) to push an outer cylinder (20a) upward, and a fine channel is formed between both cylinders (20, 20a).

5. A hydraulic jack according to claim 4,
wherein a protrusion (22) is formed at an inner side of the outer cylinder (20a) to press the check valve (21), the protrusion (22) being spaced apart from the check ball (21a) so that the outer cylinder (20a) moves upward by a predetermined load after the inner cylinder (20) initially moves upward.
